(19) United States
(12) Patent Application Publication
(10) Pub. No.: US 2021/0056645 A1
(43) Pub. Date: Feb. 25, 2021

(54) DATING WEBSITE WITH CERTIFIED QULIFICATION INFORMATION

(71) Applicant: HONG LI, weihai (CN)

(72) Inventor: HONG LI, weihai (CN)

(21) Appl. No.: 17/067,649

(22) Filed: Oct. 10, 2020

(51) Int. Cl. G06Q 50/00; G06Q 30/00; G06Q 20/12; G06Q 10/10; G06Q 50/26; G06F 16/9535

(52) U.S. Cl. CPC G06Q 50/01; G06Q 30/018; G06Q 20/123; H04N 7/141; G06Q 10/107; G06Q 50/265; G06F 16/9535; G06Q 20/127

(57) ABSTRACT

To help find dates with real information and good qualification, a website and an APP for dating provide dates' certified information such as college degree, income, occupation, house and car. Dates' photo IDs or driver licenses will also be posted up after blocking personal information, to show original head pictures and to verify ages.

### TECHNICAL FIELD

This invention is in the field of e-commerce, and is about online dating.

### BACKGROUND

Online dating can make millions of people to know each other and date.

But current online dating has disadvantages:

1. Many information and photos are fake.

2. Many information important for dating are not provided and or not certified, such as college degree, income, job position, house and car.

### SUMMARY

According to the present invention, a website and an APP for dating provide dates' certified information such as college degree, income, occupation, house and car, to help find dates with real information and good qualification. Dates' photo IDs or driver licenses will also be posted up after blocking personal information to show original head pictures and to verify ages.

### DETAILED DESCRIPTION

Users who want to date online can register on the website with a PC or on the APP down loaded from the website with a cell phone, by filling in non-certified information comprising name, sex, age, height, weight, city, and status of marriage; and filling in certified information comprising dater's college degree, income, occupation, house, and car.

Once a user selected a sex, can only view users information of opposite sex.

After filling in the non-certified information, an user can click “register” icon, and the user will be automatically accepted by the website, and the user's information will be posted up as a non-certified member on the website.

After filling in the non-certified information, an user can continue to fill in the certified information with or without clicking the “register” icon. And then, upload certificate for each item of certified information (certified information without certificate will be rejected and will not be published). After that, click “verify/register” icon, the information and the certificates will be sent to the website administrator to review. After the website administrator approves the user, the user's information will be posted up as a certified member on the website.

For certified members, photo IDs or driver licenses will also be required to be uploaded after blocking personal information to show original head pictures and to verify ages.

Names of certified members will be listed ahead of non-certified members.

The more items of the certified information, the higher rank on the member list. For example, if a member filled income, house and car, then his name will be listed ahead of a member who filled only college degree and occupation.

Name of a member who already logged in will be listed ahead of members who are not logged in. There are signs next to a member name to show whether logged in or not.

Head pictures and information filled by users will be posted up on the website and the APP. For certified members, their head pictures will be inside colored frame to be distinguished from non-certified members.

When a head picture or “view” icon next to it is clicked, a personal page will appear with more information such as self description and requirements for date.

For certified members, their photo IDs or driver licenses will show up on their personal pages. Personal pages for certified members will include more detailed information such as house size, car model and year.

There is a “video conversation” icon next to the “view” icon. A user can start a video conversation call by clicking a “video conversation” icon under another user's name of opposite sex. When a user is being called, the caller's name and head picture will appear on screen. When click “video conversation” icon on the screen, the call will be connected and video conversation begins.

Website administrator will set up fee for video conversation per unit time. A date initiating video conversation deposits fee on own account; the website automatically records video conversation time and transfers fee from the date's account to the website's account when the video interviewing is over.

There is a “send message” icon next to the “video conversation” icon for sending message. Website administrator will set up fee per email. a date deposits fee on own account before sending email; the website automatically transfers email fee from sender's account to the website's account when an email is sent.

There is a search box on top the website. Users can type in search words in the search box to search for dates.

There are search icons below the search box. Users can click the search icons to search for dates without typing search words. For example, when the search icon “city” is clicked, a list of city name will appear. When a city name is clicked, a list of members in that city will show up.

1: a method of dating online comprising:
means for registration wherein a date registers on a website using a computer, or using a cell phone with an APP down loaded from the website, by uploading head picture and filling in non-certified information comprising the date's name, age, height, weight, city, and status of marriage; and filling in certified information comprising the date's college degree, income, occupation, house, car, and uploading certificates to support the certified information;
means for the website to automatically approve non-certified information;
means for the website administrator to approve dates' certified information according to the certificates submitted;
means for listing date names which are ranked by the facts comprising whether dates are logged in, whether their information are certified, and quantity of their certified information;
means for searching daters on the website or the APP, according to dates' certified and or non-certified information.

2: the method of claim 1 further comprising means for starting a video conversation by connecting a female date and a male date on the website;
and means for paying fee for video conversation wherein the website administrator sets up video fee per unit time; a date initiating video conversation deposits fee on own account; the website automatically records video conversation time and transfers fee from the date's account to the website's account when the video conversation is over.

3: the method of claim 1 further comprising means for exchanging emails between dates;
and means for paying fee for sending an email wherein the website administrator sets up fee per email; a date deposits fee on own account to send email; after an email was sent, the website automatically transfers fee from the sender's account to the website's account.

4: the method of claim 1 wherein in a date unloads photo ID or driver license in order to list certified information.

5: a method of dating online comprising:
means for registration wherein a date registers on a website using a computer, or using a cell phone with an APP down loaded from the website, by uploading head picture and filling in non-certified information comprising the dater's name, age, height, city, status of marriage; and filling in certified information comprising the date's college degree, income, occupation, house, car, and uploading certificates to support the certified information;
means for the website to automatically approve non-certified information;
means for the website administrator to approve dates' certified information according to certificates submitted;
means for listing date names which are ranked by the facts comprising whether dates are logged in, whether their information are certified, and quantity of their certified information;
means for searching dates on the website or the APP, according to dates' certified and or non-certified information;
means for starting a video conversation by connecting a female date and a male date on the website;
and means for paying fee for video conversation wherein the website administrator sets up video fee per unit time; a date initiating video conversation deposits fee on own account; the website automatically records video conversation time and transfers fee from the date's account to the website's account when the video conversation is over.

6: a method of dating online comprising:
means for registration wherein a date registers on a website using a computer, or using a cell phone with an APP down loaded from the website, by uploading head picture and filling in information comprising the date's name, age, height, weight, city, status of marriage, college degree, income, occupation, house, car, and uploading certificates to support the information;
means for the website administrator to approve dates' information according to the certificates submitted;
means for listing date names according to dates' information;
and means for searching dates on the website or the APP, according to dates' information.
